(19) United States
(12) Patent Application Publication
(10) Pub. No.: US 2026/0146481 A1
(43) Pub. Date: May 28, 2026

(54) VEHICLE DOOR LATCH EQUIPMENT AND ASSOCIATED VEHICLE DOOR

(71) Applicant: Minebea AccessSolutions France, Alfortville (FR)

(72) Inventors: François DEBROUCKE, Alfortville (FR); Jean-Marc VERBRUGGHE, Alfortville (FR); Robin DUVAUCHELLE, Alfortville (FR)

(73) Assignee: Minebea AccessSolutions France, Alfortville (FR)

(21) Appl. No.: 19/393,826

(22) Filed: Nov. 19, 2025

(30) Foreign Application Priority Data
Nov. 22, 2024 (EP) 24315531

(51) Int. Cl. E05B 81/06; E05B 81/18; E05B 81/30; E05B 81/36; E05B 81/64

(52) U.S. Cl. CPC E05B 81/06; E05B 81/18; E05B 81/30; E05B 81/36; E05B 81/64

(57) ABSTRACT

A vehicle door latch includes an engagement mechanism for engaging with a striker and an electrical release mechanism including an electrical release motor with an output shaft and a worm arranged on the output shaft. The worm meshes with a gear wheel. The gear wheel actuates the engagement mechanism from a closed position in which the striker is retained by the engagement mechanism and an opened position in which the striker is released. The vehicle door latch also includes an additional electrical release mechanism including an additional electrical release motor. The additional electrical release mechanism acts in parallel to the electrical release mechanism to provide an additional torque force to the gear wheel.

### TECHNICAL FIELD

The present invention relates to the field of vehicle door latches to ensure the closing of vehicle doors and in particular to latches comprising an electrical release mechanism.

### BACKGROUND OF THE INVENTION

The present invention refers to a vehicle door latch equipment comprising an electrical release mechanism also called E-release mechanism.

Such an electrical release mechanism has to open the door in a whole range of conditions that will be faced during the lifetime of the vehicle.

In particular, the vehicle may cope with low temperatures that may harden the seal so that a force high enough is then necessary to open the door.

Thus, the electrical release mechanism needs to provide a fast opening while having a sufficient force to open the door in all conditions.

It is therefore a goal of the present invention to provide a vehicle door latch equipment with an electrical release mechanism capable of opening the door in a short duration and also capable of applying a force high enough to open the door in all conditions.

### SUMMARY OF THE INVENTION

The present invention refers to a vehicle door latch comprising:
an engagement mechanism configured for engaging with a striker,
an electrical release mechanism comprising an electrical release motor with an output shaft and a worm arranged on the output shaft, the said worm being configured for meshing with a gear wheel, the gear wheel being configured for actuating the engagement mechanism from a closed position wherein the striker is retained by the engagement mechanism and an opened position wherein the striker is released,
wherein the vehicle door latch comprises an additional electrical release mechanism comprising an additional electrical release motor, the additional electrical release mechanism being configured to act in parallel to the electrical release mechanism to provide an additional torque force to the gear wheel.

According to another aspect of the present invention, the additional electrical release mechanism comprises a release mechanism with an angular liberty or a freewheel mechanism so that the electrical release mechanism may rotate the gear wheel for actuating the engagement mechanism from the closed position to the opened position without applying mechanical constraints to the additional electrical release motor.

According to another aspect of the present invention, the electrical release mechanism is configured to rotate the gear wheel at a first speed and the additional electrical release mechanism is configured to rotate the gear wheel at a second speed lower than the first speed.

According to another aspect of the present invention, the additional torque force applied by the additional electrical release mechanism on the gear wheel of the electrical release mechanism is higher than the torque force applied by the electrical release mechanism on its gear wheel.

According to another aspect of the present invention, the release mechanism comprises a first cog configured for meshing with a worm arranged on the output shaft of the additional electrical release motor and a second cog configured to mesh with the gear wheel of the electrical release mechanism, the first cog being linked to the second cog.

According to another aspect of the present invention, the first cog comprises a first gear wheel and a second gear wheel arranged coaxially with the first gear wheel, the second gear wheel comprising a lever configured to be displaced between a first stopper and a second stopper of the first gear wheel to provide an angular liberty between the first gear wheel and the second gear wheel, the second cog comprising a first gear configured to mesh with the second gear wheel of the first cog and a second gear configured to mesh with the gear wheel of the electrical release mechanism.

According to another aspect of the present invention, the first stopper and the second stopper are spaced apart of an angle comprised in a range between 90° and 180°, for example 120° to provide an angular liberty comprised in a range between 90° and 180°, for example 120°.

According to another aspect of the present invention, the additional electrical release motor is configured to be activated when the electrical release motor is activated.

According to another aspect of the present invention, the additional electrical release motor is configured to be activated when a fault is detected in the electrical release mechanism.

The present invention also refers to a vehicle comprising a vehicle door latch as described previously.

### BRIEF DESCRIPTION OF THE DRAWINGS

FIG. 1 is a perspective view of a vehicle door latch according to an embodiment of the present invention;

FIG. 2 is a side view of the electrical release mechanism and the additional release mechanism according to an embodiment of the present invention;

FIG. 3 is a second perspective view of the electrical release mechanism and the additional release mechanism according to an embodiment of the present invention;

FIG. 4 is an enlarged view of the release mechanism;

FIG. 5 is a cut view of the release mechanism.

### DETAILED DESCRIPTION OF THE INVENTION

The following achievements are examples. Although, the specification refers to one or several embodiments, it does not imply that each reference refers to the same embodiment or that the features apply only to a single embodiment. Simple features of different embodiments can also be combined to provide other embodiments.

The present invention refers to a vehicle door latch 1 configured to ensure the closing of a vehicle door, in particular a side door or a trunk lid.

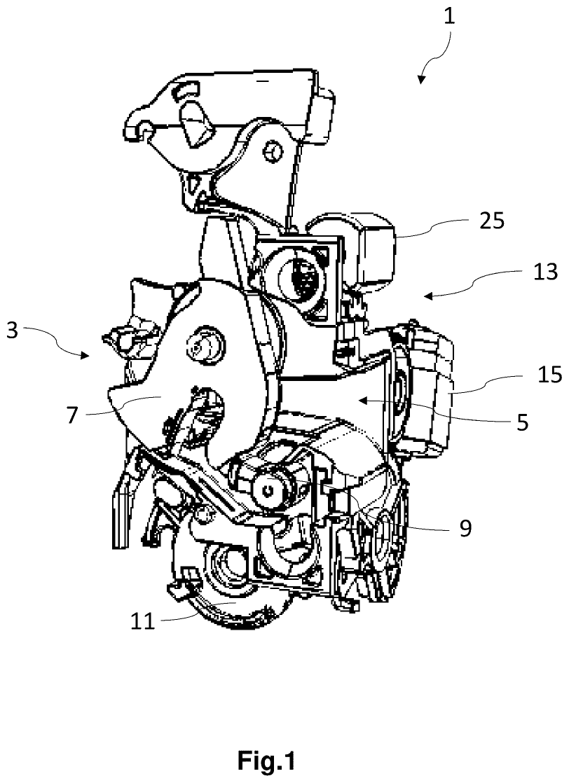

FIG. 1 represents an example of such vehicle door latch 1.

The vehicle door latch 1 comprises an engagement mechanism 3 configured for engaging with a striker (not represented). The striker is arranged on the vehicle body next to the vehicle door and is configured to be introduced into a recess 5 of the vehicle door latch 1 when the vehicle door is closed. The engagement mechanism 3 comprises a claw 7 arranged at least partially in the recess 5 and configured to move between a closed position wherein the striker is retained within the recess by the claw 7 and an opened position wherein the striker may be disengaged from the vehicle door latch 1. The engagement mechanism 3 also comprises a pawl 9 configured to rotate between a blocking position (as represented in FIG. 1) wherein the pawl 9 blocks the rotation of the claw 7 so that the striker is retained by the claw 7 and a release position wherein the pawl 9 enables the rotation of the claw 7 and therefore the release of the striker to open the door.

The engagement mechanism 3 also comprises a driver 11 configured to engage with the pawl 9 to rotate the pawl 9 between its blocking position and its release position.

The vehicle door latch 1 also comprises an electric release mechanism 13. The vehicle door latch 1 may comprise an electrical release mechanism 13 combined with a mechanical release mechanism (not represented) or only an electrical release mechanism 13.

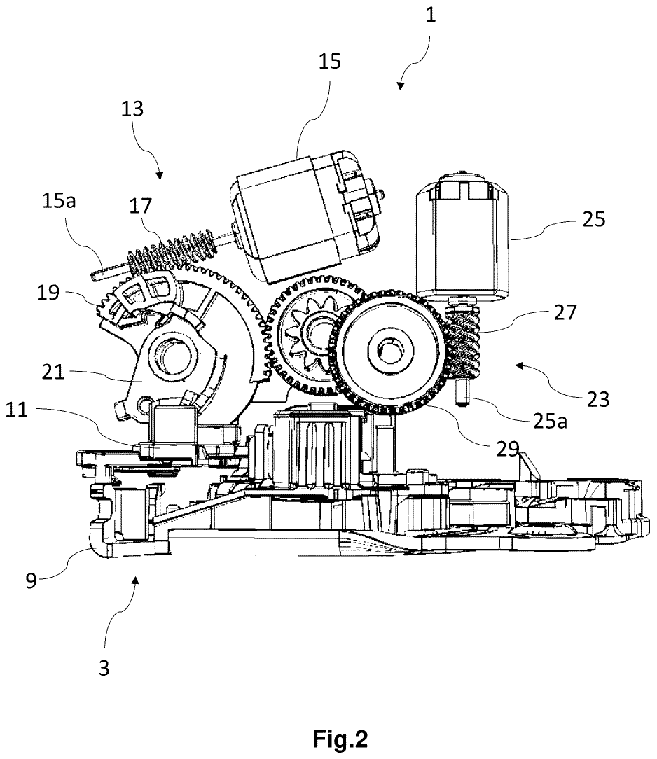

The electric release mechanism 13 comprises an electric release motor 15 with an output shaft 15a as represented in FIG. 2. A worm 17 is arranged on the output shaft 15a of the electrical release motor 15 and is configured to mesh with a gear wheel 19. The gear wheel 19 is configured to engage directly or indirectly with the driver 11 in order to actuate the engagement mechanism 3. In particular, the gear wheel 19 may be configured to rotate an intermediate lever 21 which is configured to rotate the driver 11 so that the engagement mechanism 3 is brought in a release position.

Thus, the rotation of the electric release motor 15 leads to the rotation of the gear wheel 19 via the worm 17. The rotation of the gear wheel 19 leads to the rotation of the intermediate lever 21 and consequently the rotation of the driver 11 which leads the pawl 9 in its release position and therefore to the release of the striker by the claw 7. Other configurations of electric release mechanism are also possible.

The vehicle door latch equipment 1 also comprises an additional electric release mechanism 23 configured to work in parallel to the electrical release mechanism 13 to provide an additional torque force. Such additional torque force may be necessary to open the door for example in case of a frozen door seal.

The additional electric release mechanism 23 comprises an additional electrical release motor 25 with an output shaft 25a.

In the embodiment represented in the figures, the additional electrical release mechanism 23 comprises a release mechanism 31 arranged between the additional electrical release motor 25 and the gear wheel 19. This release mechanism 31 provide an angular liberty so that the electrical release mechanism 13 may rotate the gear wheel 19 for actuating the engagement mechanism 3 from the closed position to the opened position without applying mechanical constraints to the additional electrical release motor 25.

In the present example, the release mechanism 31 comprises a comprises a first cog 33 arranged on a first shaft 34 (represented by an axis in FIG. 5). and a second cog 35 arranged on a second shaft 36 (represented by an axis in FIG. 5) different than the first shaft 34, the first cog 33 being linked to the second cog 35.

The release mechanism 31 comprises a first gear wheel 33a associated with the first cog 33 and configured for meshing with a worm 27 arranged on the output shaft 25a of the additional electrical release motor 25.

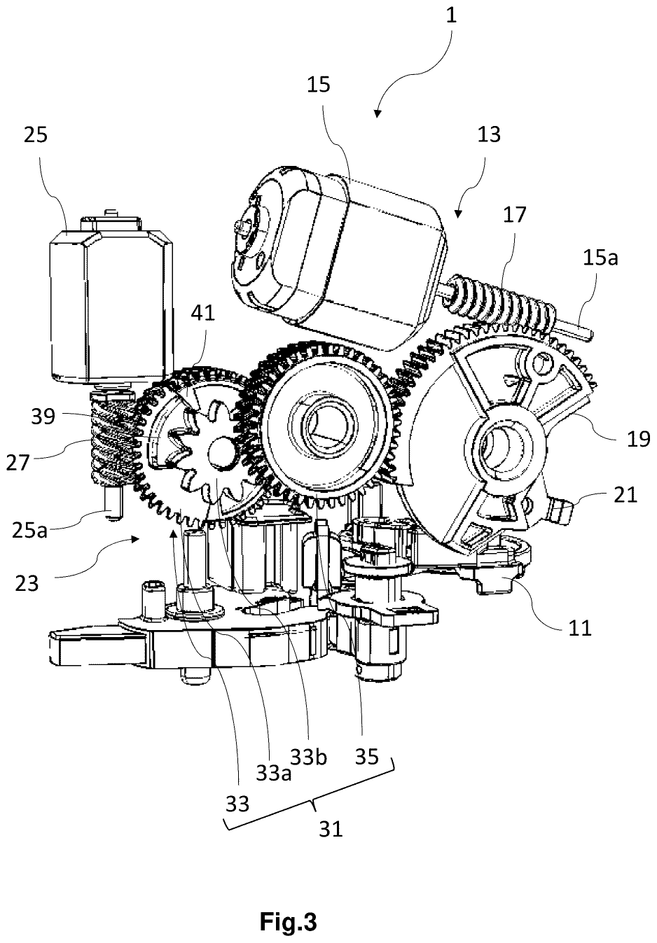

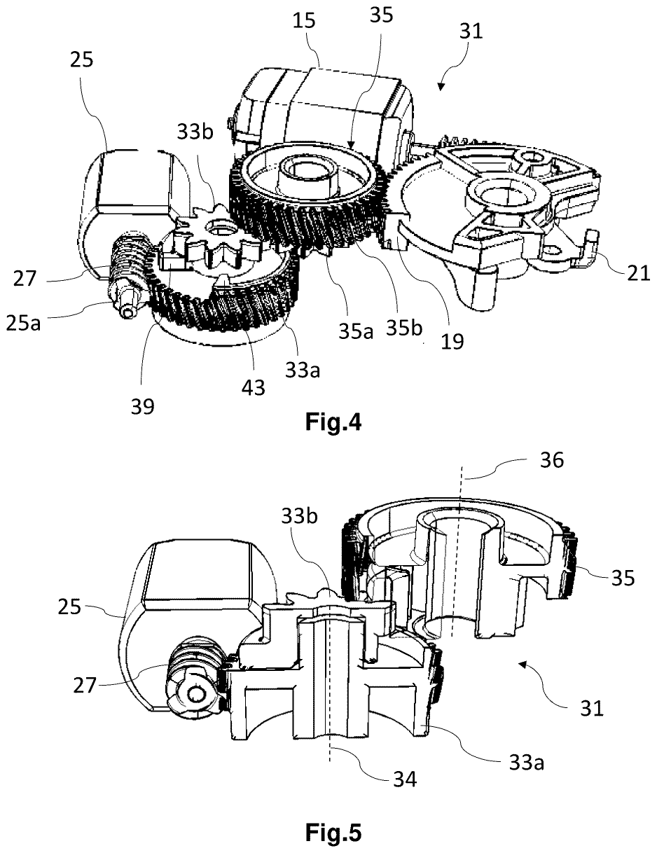

The release mechanism 31 also comprises a second gear wheel 33b associated with the first cog 33. The second gear wheel 33b is arranged coaxially with the first gear wheel 33a, the second gear wheel 33b comprising a lever 39 (visible in FIG. 3) configured to be displaced between a first stopper 41 and a second stopper 43 (visible in FIG. 4) of the first gear wheel 33a to provide an angular liberty between the first gear wheel 33a and the second gear wheel 33b.

The first cog 33 may be configured so that the lever 39 may rotate within an angular span comprised between 90° and 180°, for example 120° which may lead to a similar angular liberty. The angular liberty may be reduced depending on the angular width of the lever 39. The angular liberty may be chosen with respect to the required rotation of the gear wheel 19 to bring the engagement mechanism 3 in an opened position.

The second cog 35 comprises a first gear 35a configured to mesh with the second gear wheel 33b associated with the first cog 33 and a second gear 35b configured to mesh with the gear wheel 19 of the electrical release mechanism 13.

The size (number of teeth) of the different gears and gear wheels of the release mechanism can be chosen so that the electrical release mechanism 13 rotates the gear wheel 19 at a first speed and the additional electrical release mechanism 23 rotates the gear wheel 19 at a second speed lower than the first speed. If the additional electrical release motor 25 is similar to the electrical release motor 15, the torque provided by the additional electrical release mechanism 23 to the gear wheel 19 may be higher than the torque provided by the electrical release motor 15 (in practice, the additional electrical release motor 25 may have a reduced power (in order to limit the energy consumption) with respect to the electrical release motor 15 but the release mechanism 31 may allow to reduce the speed and to increase the torque provided by the additional electrical release motor 25 to the gear wheel 19). The difference of rotational speed or torque may also be obtained with an additional electrical release motor 25 different than the electrical release motor 15.

With such configuration, the electrical release mechanism 13 enables a fast opening of the vehicle door latch 1 in normal conditions due to the high speed transmitted to the gear wheel 19 and the additional electrical release mechanism 23 enables an opening in severe or abnormal conditions due to the additional torque provided to the gear wheel 19. Even if the opening of the vehicle door latch 1 is slower than in normal conditions, the vehicle door latch 1 may be opened without the assistance of the user so that the comfort of the user is improved without requiring an oversized electrical release motor 15.

Furthermore, such configuration of the additional electrical release motor 25 and the release mechanism 31 is compact and limit therefore the bulk of the vehicle door latch 1.

Other configuration of release mechanisms 31 providing an angular liberty are also possible. Alternatively, a release mechanism 31 based on a freewheel (not represented) may be used instead of a release mechanism 31 with an angular liberty. The freewheel is then configured so that the additional electric release mechanism 23 can transmit a torque to the gear wheel 19 but not the opposite so that no mechanical constraints can be applied to the additional electrical release motor 25 by the electrical release mechanism 13.

According to a particular embodiment, the additional electrical release motor 25 is configured to be activated when the electrical release motor 15 is activated, for example when the user pushes on a button or pull a handle to open the door. Both motors are activated at the same time. However, as electrical release motor 15 is configured to rotate the gear wheel 19 at a higher speed than the additional electrical release motor 25, the gear wheel is driven in rotation by the sole electrical release motor 15 during a first time span. Due to the release mechanism, the additional electrical release mechanism 23 does not disturb the drive of the gear wheel 19 by the electrical release motor 15.

If the torque provided by the electrical release motor 15 is sufficient to open the vehicle door latch 1, then the vehicle door latch 1 is opened by the sole electrical release motor 15 even if the additional electrical release motor 25 is also activated. After opening of the vehicle door latch 1, both the electrical release motor 15 and the additional electrical release motor 25 are deactivated.

If the torque provided by the electrical release motor 15 is not sufficient to open the vehicle door latch 1, for example due to a frozen door seal. After a short time lapse the additional electrical release motor 25 has rotated the first gear wheel enough for the lever 39 to come into contact with one of the stoppers 41 or 43. The additional electrical release motor 25 provides then an additional torque to the gear wheel 19 via the release mechanism 31 which enables to open the vehicle door latch 1. After opening of the vehicle door latch 1, both the electrical release motor 15 and the additional electrical release motor 25 are deactivated.

Thus, in this particular embodiment, both the electrical release motor 15 and the additional electrical release motor 25 are activated from the beginning of the opening process but in most cases, only the electrical release motor 15 is useful to open the vehicle door latch 1.

According to another embodiment, only the electrical release motor 15 is activated when the user pushes on a button or pull a handle to open the door. The additional electrical release motor 25 is configured to be activated only when a fault is detected in the electrical release mechanism 13. The fault may correspond to a blocking of the electrical release motor 15 due to a resistant force of the door, for example because of a frozen seal. When such fault is detected, the additional electrical release motor 25 is activated to provide an additional torque to the gear wheel to open the vehicle door latch 1. With this embodiment, the time required to open the door in severe conditions (frozen seal, etc . . . ) is higher but the energy consumption is reduced due to the fact that the additional electrical release motor 25 is activated only when it is required.

Thus, the use of an electrical release motor 15 and an additional electrical release motor 25 enables a fast opening of the vehicle door latch 1 and therefore of the vehicle door in normal conditions and a slower opening of the vehicle door latch in severe conditions so that the door may be opened in most conditions without requiring the help of the user. Furthermore, the additional electrical release motor may have a low consumption due to the release mechanism that enables to obtain a high torque thanks to the gearing. The consumption may be further reduced if the additional electrical release motor 25 is activated only if required (which would lead to an opening of a longer duration). Furthermore, due to the small size of the additional electrical release motor 25 and the release mechanism 31, such feature barely increases the bulk of the vehicle door latch 1.

The present invention refers also to a vehicle comprising a vehicle door latch 1 as disclosed above.

1-10. (canceled)

11. A vehicle door latch, comprising:
an engagement mechanism configured to engage with a striker;
an electrical release mechanism comprising an electrical release motor with an output shaft and a worm arranged on the output shaft, the worm being configured to mesh with a gear wheel, the gear wheel being configured to actuate the engagement mechanism from a closed position wherein the striker is retained by the engagement mechanism and an opened position wherein the striker is released; and
an additional electrical release mechanism comprising an additional electrical release motor, the additional electrical release mechanism being configured to act in parallel to the electrical release mechanism to provide an additional torque force to the gear wheel.

12. The vehicle door latch in accordance with claim 11, wherein the additional electrical release mechanism comprises a release mechanism with an angular liberty or a freewheel mechanism so that the electrical release mechanism may rotate the gear wheel to actuate the engagement mechanism from the closed position to the opened position without applying mechanical constraints to the additional electrical release motor.

13. The vehicle door latch in accordance with claim 11, wherein the electrical release mechanism is configured to rotate the gear wheel at a first speed and the additional electrical release mechanism is configured to rotate the gear wheel at a second speed lower than the first speed.

14. The vehicle door latch in accordance with claim 11, wherein the additional torque force applied by the additional electrical release mechanism on the gear wheel of the electrical release mechanism is higher than the torque force applied by the electrical release mechanism on the gear wheel.

15. The vehicle door latch in accordance with claim 12, wherein the release mechanism comprises a first cog configured for meshing with a worm arranged on the output shaft of the additional electrical release motor and a second cog configured to mesh with the gear wheel of the electrical release mechanism, the first cog being linked to the second cog.

16. The vehicle door latch in accordance with claim 15, wherein the first cog comprises a first gear wheel and a second gear wheel arranged coaxially with the first gear wheel, the second gear wheel comprising a lever configured to be displaced between a first stopper and a second stopper of the first gear wheel to provide an angular liberty between the first gear wheel and the second gear wheel, the second cog comprising a first gear configured to mesh with the second gear wheel of the first cog and a second gear configured to mesh with the gear wheel of the electrical release mechanism.

17. The vehicle door latch in accordance with claim 16, wherein the first stopper and the second stopper are spaced apart at an angle comprised in a range between 90° and 180° to provide an angular liberty comprised in a range between 90° and 180°.

18. The vehicle door latch in accordance with claim 16, wherein the first stopper and the second stopper are spaced apart at an angle of 120° to provide an angular liberty of 120°.

19. The vehicle door latch in accordance with claim 11, wherein the additional electrical release motor is configured to be actuated when the electrical release motor is actuated.

20. The vehicle door latch in accordance with claim 11, wherein the additional electrical release motor is configured to be actuated when a fault is detected in the electrical release mechanism.

21. A vehicle, comprising:
the vehicle door latch in accordance with claim 11.
